(19) United States
(12) Patent Application Publication
(10) Pub. No.: US 2006/0224411 A1
(43) Pub. Date: Oct. 5, 2006

(54) Method of constructing and using a memorial

(76) Inventors: Sheng-Yen Chang, Elmhurst, NY (US); Min-Chiu Tson, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/370,058

(22) Filed: Mar. 8, 2006

(30) Foreign Application Priority Data
Apr. 1, 2005 (TW) 94110435

(51) Int. Cl. G06Q 99/00

(52) U.S. Cl. 705/1

(57) ABSTRACT

A method of constructing and using a memorial comprises the steps of: taking a sample of a physiological composite of a biological individual, such as oral squamous cells of a person; packaging the physiological composite in a sealed unit to produce a memento; storing the memento in a custodian place; and conducting a ceremony activity for the biological individual in the custodian place. The invention further comprises steps of recording memorial data of the biological individual; integrating and compiling the memorial data to produce a digital memorial file; storing the digital memorial file in a data storage unit controlled by a computer; and playing back the digital memorial file to conduct a digital retrospective activity for the biological individual at the custodian place so as to make the memorial contents more friendly and lively.

### BACKGROUND OF THE INVENTION

1. Field of the Invention

The present invention relates to a method of constructing and using a memorial, and more particularly to a method of constructing and using a memorial for a biological individual, such as a person.

2. Description of Related Art

As is generally known, the arrangements for a funeral of a deceased person include handling the deceased's body, commemorating the deceased person, and conducting memorial activities at a later time.

In the traditional way of handling a dead body, a gravesite is first found on a mountain or a graveyard, and then the dead body is buried in the grave. At a later time, relatives and friends of the dead person can visit the gravesite on the mountain or the graveyard to conduct memorial activities such as cleaning the grave of a dead person and commemorating the dead person.

In the above traditional way, the arrangement for the funeral is complicated, and relatives and friends have to spend lots of time, effort, and money. Furthermore, the large outdoor space occupied by the grave is not easy to maintain and cannot be permanent, thus relatives and friends of the dead person have to spend more time and expenses upon the maintenance of the gravesite.

In another way of handling a dead body, the dead body is cremated, and then the ash is placed in an ash jar. However, the size of the ash jar is still relatively large. In addition, the contents of memorial activities conducted by the relatives and friends of the dead person are often dull and boring, and descendents of the deceased commonly forget the dead person as time goes by.

From the description above, the traditional ways are obviously inconvenient and have existing shortcomings that demand further improvements.

In view of the foregoing shortcomings, the inventor of the present invention, based on years of experience in the related field and having conducted extensive research, has applied related theories, and finally invented a feasible design of the present invention to effectively overcome the previously described shortcomings.

### SUMMARY OF THE INVENTION

A primary object of the present invention is to provide a method of constructing and using a memorial that is in compliance with environmental requirements, makes maintenance easier, and storage more permanent.

A secondary object of the present invention is to provide a method of constructing and using a memorial to facilitate conducting a blessing ceremony when a biological individual is alive, to simplify the arrangement of a funeral after the biological individual dies, and to facilitate conducting a memorial ceremony for the biological individual after the biological individual dies, so as to save the time, effort, and expense of handling the funeral and conducting the memorial ceremony.

Another object of the present invention is to provide a method of constructing and using a memorial that uses friendly and lively contents to conduct a retrospective gathering when a biological individual is alive and a memorial ceremony after the biological individual dies.

To achieve the foregoing objects, the present invention provides a method of constructing and using a memorial comprising the steps of:

taking a sample of a physiological composite of a biological individual;

packaging the physiological composite in a sealed unit to produce a memento;

storing the memento in a custodian place; and

conducting a ceremony activity for the biological individual in the custodian place.

Since the sampling and packaging of the physiological composite are simple and easy, and the volume of the memento is small and easily stored in the custodian place, the production of the memento further complies with environmental regulations, makes maintenance easier, and storage more permanent. Furthermore, the physiological composite of the biological individual can be sampled to produce a memento to be stored in a custodian place, when the biological individual is either alive or after the biological individual dies. Therefore, a blessing ceremony for the biological individual can be conducted when the biological individual is alive, an arrangement of a funeral for the biological individual is simplified, and a memorial ceremony for the biological individual can be conducted after the biological individual dies.

In a preferred embodiment, the step includes recording memorial data of the biological individual.

In a preferred embodiment, the step includes integrating and compiling the memorial data to produce a digital memorial file.

In a preferred embodiment, the step includes storing the digital memorial file in a data storage unit controlled by a computer.

In a preferred embodiment, the step includes playing back the digital memorial file to conduct a digital retrospective activity for the biological individual in the custodian place, wherein the digital retrospective activity is a retrospective gathering held when the biological individual is alive.

In a preferred embodiment, the step includes playing back the digital memorial file to conduct a digital retrospective activity for the biological individual in the custodian place, wherein the digital retrospective activity is a memorial ceremony held after the biological individual dies.

To sum up, the digital memorial file records the life of the biological individual in a friendly audio/video form, so that the contents of the retrospective gathering held when the biological individual is alive and the contents of the memorial ceremony held after the biological individual dies can be more friendly and lively.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of constructing and using a memento according to the method of constructing and using a memorial of the present invention;

FIG. 2 shows a preferred embodiment as depicted in FIG. 1;

FIG. 3 is a flow chart of constructing and using a digital memorial file according to the method of constructing and using a memorial of the present invention; and

FIG. 4 shows a preferred embodiment as depicted in FIG. 3.

### DETAILED DESCRIPTION OF THE PREFERRED EMBODIMENTS

The present invention is illustrated with a preferred embodiment and attached drawings. However, the invention is not intended to be limited thereby.

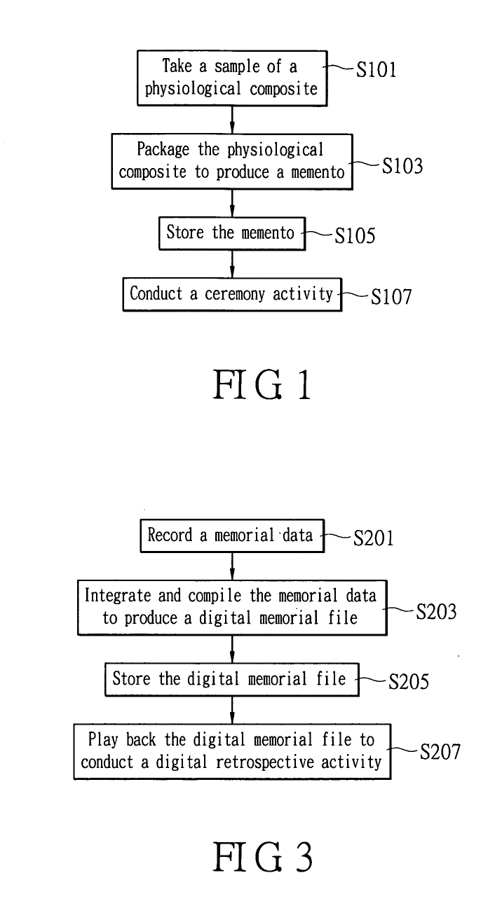

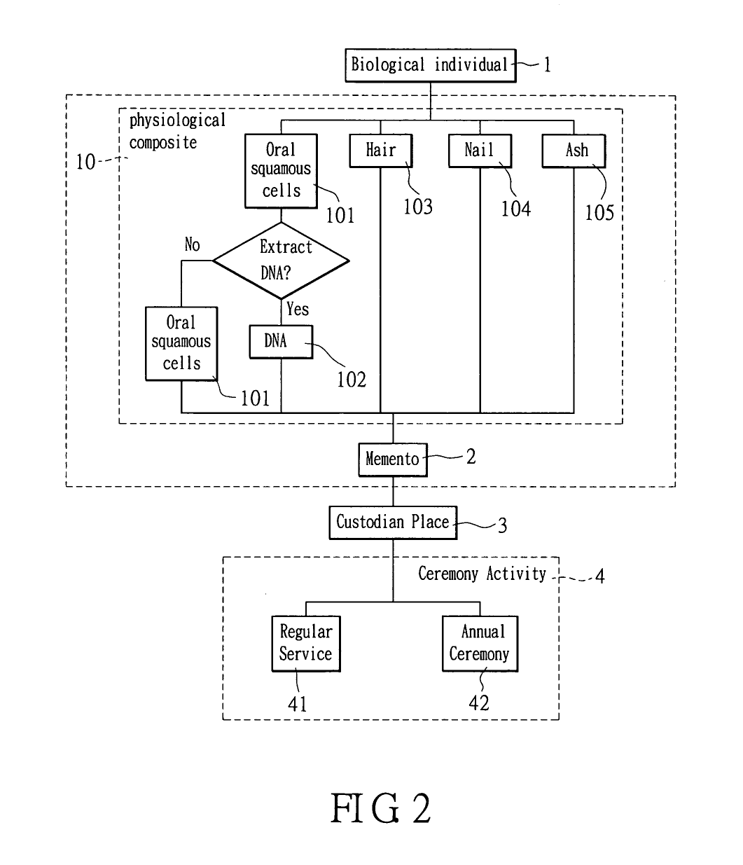

Referring to FIGS. 1 and 2, a method of constructing and using a memorial of the invention comprises the following steps:

Taking a sample of a physiological composite of a biological individual (S101).

The biological individual 1 can be a person, and the physiological composite 10 can be sampled when the biological individual 1 is either alive or after the biological individual 1 dies. If the physiological composite 10 is sampled when the biological individual 1 is alive, the physiological composite 10 can be oral squamous cells 101, deoxyribonucleic acids (DNAs) 102, a hair 103, or a nail 104 that facilitates sampling. However, the sample can be taken from any other portion of the biological individual 1 as well, wherein the deoxyribonucleic acids (DNAs) 102 can be extracted from the oral squamous cells 101. If the physiological composite 10 is sampled after the biological individual 1 dies, the physiological composite 10 can be a hair 103, a nail 104, or ash 105 after the biological individual 1 has been cremated, so that the sample can be taken in a respectful manner.

Packaging the physiological composite in a sealed unit to produce a memento (S103).

The sealed unit can be made of a transparent material and further has a color material. For example, the sealed unit can be an artificial amber or an artificial crystal. The sampling and packaging of the physiological composite 10 is simple and easy, and the memento 2 is small, clean, and easy to maintain.

Storing the memento in a custodian place (S105).

This step further includes storing the memento 2 in a storage apparatus and storing the storage apparatus in a custodian place 3. The storage apparatus can be a safety deposit box, and the custodian place 3 can be a religious building such as a temple. The memento 2 is small and easy to store in the custodian place 3, and thus the production of the memento 2 further complies with environmental regulations and provides easier maintenance. Such arrangements simplify the arrangements of a funeral after the biological individual 1 has died, and also can prevent any damage due to natural or man-made calamities such as earthquakes, floods, or fires, and allows a much longer storage time to be possible.

Conducting a ceremony activity for the biological individual in the custodian place (S107).

This step further includes providing a place for conducting the ceremony activity 4, and the place can be a hall of a temple or an outdoor square of a temple.

In FIG. 2, a temple having a plurality of mementos 2 of biological individuals 1 provides various ceremony activities 4 including a regular service 41 and an annual ceremony 42 (such as a Buddhist Observance and a Joint Prayer). Therefore, a blessing ceremony is provided for the biological individuals 1 who are alive, and a memorial ceremony is provided for the other biological individuals 1 who have passed on.

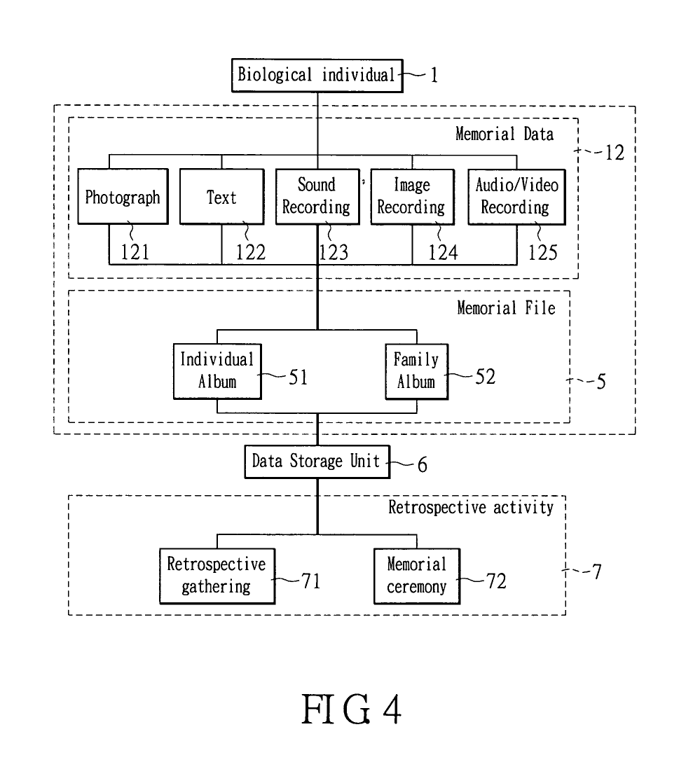

Referring to FIGS. 3 and 4, the method of constructing and using a memorial of the invention further comprises the following steps:

Recording a memorial data of the biological individual (S201).

The memorial data 12 is selected from at least a photograph 121, text 122, a sound recording 123, an image recording 124, or an audio/video recording 125 that record the details of the life and different memorable data about the biological individual 1.

Integrating and compiling the memorial data to produce a digital memorial file (S203);

The digital memorial file 5 can be an individual album 51 of the biological individual 1 or a family album 52 that includes the biological individual 1. The memorial data 12 can be edited and dubbed with background music according to its nature to achieve the required feeling for the digital memorial file 5.

Storing the digital memorial file in a data storage unit controlled by a computer (S205).

The digital memorial file 5 is stored in a data storage unit 6 controlled by a computer to facilitate its storage and management. The data storage unit 6 controlled by a computer can be a database, a compact disc (CD), a digital versatile disc (DVD), or a chip etc.

Playing back the digital memorial file to conduct a digital retrospective activity for the biological individual in the custodian place (S207). This step further includes providing a place for conducting the digital retrospective activity 7, and the place can be an audio/video viewing room of the temple. The digital retrospective activity 7 can be a retrospective gathering 71 held when the biological individual 1 is alive, or a memorial ceremony 72 held after the biological individual 1 dies.

The digital memorial file 5 records the life of the biological individual 1 in a friendly audio/video form, so that the contents of the retrospective gathering held when the biological individual 1 is alive and the contents of the memorial ceremony held after the biological individual 1 dies can be more friendly and lively. Therefore, an alive person and his/her relatives and friends can go to the temple to view his/her memorial file and to conduct a blessing ceremony, or relatives and friends of a dead person can go to the temple to conduct a memorial ceremony, so as to achieve the effect of attending to the funeral rites and commemorating the dead person.

Therefore, the method of constructing and using a memorial of the present invention has the following advantages:

1. The physiological composite can be sampled and packaged easily, and the memento is small and easy to store in the custodian place. Therefore, the production of the memento further complies with environmental regulations and makes maintenance easier and the storage more permanent.

2. The physiological composite of the biological individual is sampled to produce a memento to be stored in a custodian place, when the biological individual is either alive or after the biological individual dies. Therefore, a blessing ceremony for the biological individual can be conducted when the biological individual is alive, an arrangement of a funeral for the biological individual is simplified, and a memorial ceremony for the biological individual can be conducted after the biological individual dies.

3. The digital memorial file records the life of the biological individual in a friendly audio/video form, such that the contents of the retrospective gathering held when the biological individual is alive and the contents of the memorial ceremony held after the biological individual dies are more friendly and lively.

In summation of the description above, the present invention complies with the requirements of patent applications, and is thus submitted for the patent application.

While the invention has been described by means of a specification with accompanying drawings of specific embodiments, numerous modifications and variations can be made thereto by those skilled in the art without departing from the scope and spirit of the invention set forth in the claims.

What is claimed is:

1. A method of constructing and using a memorial, comprising the steps of:
taking a sample of a physiological composite of a biological individual;
packaging said physiological composite in a sealed unit to produce a memento;
storing said memento in a custodian place; and
conducting a ceremony activity for said biological individual in said custodian place.

2. The method of constructing and using a memorial of claim 1, wherein said biological individual is a person.

3. The method of constructing and using a memorial of claim 1, wherein said physiological composite of said biological individual is oral squamous cells, deoxyribonucleic acids (DNAs), a hair, a nail, or ash.

4. The method of constructing and using a memorial of claim 1, wherein said physiological composite is sampled when said biological individual is alive.

5. The method of constructing and using a memorial of claim 1, wherein said physiological composite is sampled after said biological individual dies.

6. The method of constructing and using a memorial of claim 1, wherein said sealed unit is made of a transparent material.

7. The method of constructing and using a memorial of claim 1, wherein said step of storing said memento in a custodian place comprises steps of storing said memento in a storage apparatus and storing said storage apparatus in a religious building.

8. The method of constructing and using a memorial of claim 7, wherein said storage apparatus is a safety deposit box.

9. The method of constructing and using a memorial of claim 1, wherein said step of conducting a ceremony activity for said biological individual in said custodian place further comprises a step of providing a place for conducting said ceremony activity.

10. The method of constructing and using a memorial of claim 1, further comprising a step of recording a memorial data of said biological individual.

11. The method of constructing and using a memorial of claim 10, wherein said memorial data is selected from at least a photograph, text, a sound recording, an image recording, or an audio/video recording.

12. The method of constructing and using a memorial of claim 10, further comprising a step of integrating and compiling said memorial data to produce a digital memorial file.

13. The method of constructing and using a memorial of claim 12, wherein said digital memorial file is an individual album of said biological individual or a family album including said biological individual.

14. The method of constructing and using a memorial of claim 12, further comprising a step of storing said digital memorial file in a data storage unit controlled by a computer.

15. The method of constructing and using a memorial of claim 14, further comprising a step of playing back said digital memorial file to conduct a digital retrospective activity for said biological individual in said custodian place, wherein said digital retrospective activity is a retrospective gathering held when said biological individual is alive.

16. The method of constructing and using a memorial of claim 14, further comprising a step of playing back said digital memorial file to conduct a digital retrospective activity for said biological individual in said custodian place, wherein said digital retrospective activity is a memorial ceremony held after said biological individual dies.
